(19) United States
(12) Patent Application Publication
(10) Pub. No.: US 2023/0117050 A1
(43) Pub. Date: Apr. 20, 2023

(54) THERMOSETTING COMPOSITIONS FOR ADDITIVE MANUFACTURING

(71) Applicant: Polynt Composites USA, Inc., Carpentersville, IL (US)

(72) Inventors: Steven L. Voeks, Smithville, MO (US); Robert M. Adams, Overland Park, KS (US); Blaze Heckert, Spring Hill, KS (US); Rick Pauer, Carpentersville, IL (US); Michael Mathews, Carpentersville, IL (US)

(21) Appl. No.: 18/047,622

(22) Filed: Oct. 18, 2022

Related U.S. Application Data
(60) Provisional application No. 63/257,102, filed on Oct. 18, 2021.

(51) Int. Cl. B29C 64/106; B33Y 80/00

(52) U.S. Cl. CPC B29C 64/106; B33Y 80/00; B29K 2023/083

(57) ABSTRACT

An additive manufacturing composition comprising a thermosetting material such as a vinyl ester and/or an unsaturated polyester, a reinforcing material, and a low-profile additive. When the composition is cured to form an object, the cured object has a CLTE of 10 um/m-° C. or less in X- and/or Y-directions, and/or 100 um/m-° C. or less in a Z-direction. Additive manufacturing methods can use the composition to produce an object having high dimensional stability.

### FIELD

This application relates generally to thermosetting compositions and methods of making objects from such compositions. In particular, the present compositions and methods comprise thermosetting compositions for making objects by additive manufacturing.

### BACKGROUND

Thermosetting compositions are materials that are irreversibly hardened after curing. Curing is induced by heat may be promoted with a catalyst. Heat is not necessarily applied externally, but is often generated by the exothermic reaction of components of the composition. Curing produces chemical reactions that create cross-linking between polymer chains. Once hardened, a cured thermoset cannot be melted for reshaping, in contrast to thermoplastic polymers.

Thermosetting compositions can be used in a variety of applications and methods, such as in coatings, adhesives, sealants, castings, 3D printing, solid foams, wet lay-up laminating, pultrusion, gelcoats, filament winding, pre-pregs, and molding. Common usages of thermosetting compositions include reactive injection molding, extrusion molding, compression molding, and spin casting.

Additive manufacturing, also known as three-dimensional (3D) printing, is used in a wide array of industries for the manufacturing of objects. Such additive manufacturing may be performed with polymers, alloys, powders, wires, or similar feed materials that transition from a liquid or granular state to a cured, solid component. Additive manufacturing may be used to quickly and efficiently manufacture three-dimensional objects layer-by-layer.

Polymer-based additive manufacturing is presently accomplished by feeding polymer materials through a nozzle that is precisely located over a bed or other support. Objects are manufactured by the sequential deposition of layers of materials above the previously deposited layers. Large scale polymer based additive manufacturing of objects requires consideration of thermal and mechanical properties that can cause materials designed for 3D printing to fail due to warping or other deformation. There is a continuing need for improved additive manufacturing materials and methods.

Additive manufacturing techniques and processes generally involve the buildup of one or more materials to make an object, in contrast to subtractive manufacturing methods. Additive manufacturing techniques are capable of fabricating complex components from a wide variety of materials. Generally, a freestanding object can be fabricated from a computer-aided design (CAD) model.

Polymer additive manufacturing generally includes forming and extruding a bead of flowable material (such as a molten thermoplastic material), applying such bead of material in a stratum of layers, to form a facsimile of an object, and machining such facsimile to produce an end product. The process is generally achieved by means of an extruder mounted on an actuator with controlled motion along at least the X, Y, and Z-directions. The extruder deposits beads of the flowable material at precise locations in the X-Y plane to form a layer, then moves in the Z-direction and begins forming the next layer. In some cases, the flowable material may be infused with a reinforcing material (e.g., glass or carbon fiber) to enhance the material's strength. The deposition process may be repeated so that successive layer(s) of flowable material is deposited upon existing layer(s) to build up and manufacture a desired object. The new layer of flowable material is deposited at a temperature sufficient enough to allow the new layer of flowable material to melt and fuse with a previously deposited layer of flowable material, thus producing a solid part.

Polymer additive manufacturing has generally employed thermoplastics. When building with polymers the mechanical strength of a thermoplastic typically increases with the molecular weight and the degree of branching of side chains. Unfortunately, this also results in an elevation of the melt viscosity and melting point. Fused deposition manufacturing (FDM) requires that a layer maintains tolerance immediately after deposition along with a structural bond to subsequent layers. This structural bond is formed by physically pushing the polymer melt into the previous layer. Therefore, the resistance to melt flow is an important parameter and the extrusion of high strength thermoplastics requires elevated temperatures that aggravate thermal distortion.

Large objects made by polymer additive manufacturing continue to face a number of technical challenges, including challenges for printing and curing thermosetting materials.

### SUMMARY

As one aspect of the present invention, additive manufacturing compositions comprising a thermosetting material are provided. When the compositions are cured, they form objects having surprisingly good dimensional stability as well as other desirable properties. By way of example, an object produced from curing the present compositions can have a coefficient of linear thermal expansion (CLTE) of 10 um/m-° C. or less in X and Y directions, and 100 um/m-° C. or less in a Z direction, over a temperature range of 0° C. to 160° C., and/or a CLTE over a temperature range of 20° C. to 97° C. of 5 um/m-° C. or less in X- and/or Y-directions.

The present compositions comprise a thermosetting material comprising a cross-linkable component having a high level of unsaturation (for example, greater than 50% unsaturation); a low profile additive; and a reinforcing material. The low profile additive can have a low solubility in thermosetting material. The thermosetting additive manufacturing composition can have a viscosity of at least about 1,000,000 cps and/or a thixotropic index of at least 5.0 and/or an acid number of at least about 15 mg KOH/g. The thermosetting material can comprise a vinyl ester component (such as a toughened vinyl ester resin) and/or an unsaturated polyester component (such as a condensation product of a glycol and maleic acid or anhydride).

As yet another aspect, methods of manufacturing objects using the present compositions are provided. The compositions can be used in additive manufacturing or other processes to produce objects having surprisingly high dimensional stability, including at high temperatures as high as 150° C. or 200° C.

### BRIEF DESCRIPTION OF THE DRAWING

The present disclosure can be better understood from the following detailed description when read with the accompanying drawing figure. The features are not necessarily drawn to scale.

FIG. 1 shows CLTE measurements in the X- and Y-directions for panels made by additive manufacturing using curable compositions, including a preferred embodiment of the present compositions (Example 2C).

### DETAILED DESCRIPTION

In most polymeric materials for additive manufacturing, warpage and/or shrinkage can cause concerns with internal stresses as polymers cool (after melting for deposition) or in thermoset cure during crosslinking. This present disclosure discusses concerns with materials for additive manufacturing which are generally seen with large format printers but specifically as it relates to epoxy modified ester-based print media, such as a composition comprising a vinyl ester resin. Examples are presented that will show significant warpage and what caused those issues, as well as examples on how to correct warpage issues with the proper filler or reinforcement selection that minimizes warpage. In thermoplastic print media the solution often involves using carbon fiber to limit warpage in the “Z” direction. In reactive thermosets, the fiber reinforcements such as glass fiber or carbon fiber can be used as well, but applications that do not need or want fibers to be used, shrink control additives can be used as an alternative, while being extremely beneficial for warpage reduction. The present disclosure focuses on the results found in controlling shrinkage in ambient processing of pumpable high-viscosity liquids, with ambient cured thermoset 3D print materials. Shrink control technology also allows for faster deposition rates for faster print speeds in both high and low-resolution printers of any size. Mechanical and thermal test data will show how low-shrink technology can be employed without the loss of modulus and CLTE.

As one aspect, the present invention provides a composition comprising a thermosetting material comprising a cross-linkable component; a low profile additive; a reinforcing material; and a reinforcing material. In some embodiments, the thermosetting material has a high level of unsaturation (i.e., greater than about 50% unsaturation). By way of example, the thermosetting material can have at least about 55% unsaturation, or at least about 60%, or at least about 65% unsaturation, or at least about 70%, or at least about 75% unsaturation; in some embodiments, the thermosetting material has at most about 95% unsaturation, or at most about 90%, or at most about 85% unsaturation, or at most about 80%, unsaturation; it is expressly contemplated that any of the foregoing minimums and maximums can be combined to form a selected range. The percent unsaturation can be calculated on a weight or molar basis. The composition can be combined with an initiator of free-radical cross-linking and cured to form an object with surprisingly high dimensional stability. In some embodiments, the composition comprises about 12 to 45 wt % (alternatively about 15 to 30%, or about 22.5%) of an unsaturated polyester component having a high level of unsaturation (greater than about 50% unsaturation). In some embodiments, the composition comprises about 7 to 30 wt % (alternatively about 10 to 20%, or about 15%) of a vinyl ester component. In some embodiments, the composition comprises about 3 to 30 wt % (alternatively about 10 to 20%, about 7 to 25%, or about 12 to 18%, or about 15%) of the low-profile additive. In some embodiments, the composition comprises about 5 to 25 wt % (alternatively about 10 to 20%, or about 15%) of an ethylenically unsaturated monomer. In some embodiments, the composition comprises about 5 to 50 wt % (alternatively 15 to 50 wt %, or about 20 to 40%, or about 30%) of the reinforcing material (such as carbon fibers, glass fibers, natural fibers, or a mixture thereof).

As another aspect, a method of manufacturing an object is provided comprising applying and curing the present composition to form the object. In some embodiments, the method is an additive manufacturing method which comprises depositing a first layer of thermosetting material on a support at a deposit temperature; and curing the first layer of the thermosetting material, wherein the peak temperature during curing is within a selected range. The method can also comprises depositing a second layer of thermosetting material on the first layer opposite the support while the first layer undergoes exothermic reaction, and the first layer releases heat to the second layer. In some embodiments, the second layer is deposited after the first layer has reached a temperature between about 38 and about 43° C.; or, one does not begin to deposit the second layer on the first layer before the first layer has reached a temperature of about 43° C. or less. A third layer of the thermosetting material can be deposited on the second layer and opposite the first layer and the support, followed by fourth, fifth, and more layers deposited upon the prior layer, until the desired height of the object is achieved. In some embodiments, the method comprises depositing layers such that each layer does not exceed 127° C.

Compositions and methods disclosed herein are adapted for making objects by additive manufacturing. As used herein, “additive manufacturing” refers to making an object by adding material rather than removing material, such as by building one layer on top of a previous layer and encompasses various manufacturing and prototyping techniques known under a variety of names, including freeform fabrication, 3D printing, rapid prototyping/tooling, and others. Additive manufacturing can also refer to any method where an object is made by depositing layer upon deposited layer. Each layer will have the desired dimensions and shape such that together the layers form a three-dimensional, engineered structure.

As used herein, an “object” includes an article of manufacture, preferably a polymer composite article, made by curing the present thermosetting composition. In some embodiments, the object is made via additive manufacturing, for example, a polymer composite article made via large-scale additive manufacturing. It is contemplated that additive manufacturing may be used to make a facsimile of the object and other techniques, including subtractive techniques such as machining, may be used to finalize the object, which is still considered as made by additive manufacturing. In some embodiments, the present objects comprise a plurality of layers, for example, at least 10 layers, or at least 20 layers, or at least 100 layers, or more.

Large-scale additive manufacturing differs from small-scale (e.g., table-top) 3D printing in several respects. Large-scale additive manufacturing generally has dimensions on the order of feet or meters rather than inches or centimeters. For example, the present methods and compositions can be used to provide objects having a size greater than one cubic meter. Build size can refer to the volume defined by the outer boundaries of the object. For example, a square open at both ends that has sides with a length of 2 m and a height of 3 m is said to have a build size of 12 m³, though the interior of the square is hollow. Large-scale additive manufacturing can refer to manufacturing objects having a length in an X and/or Y direction of at least 1 m, or a height in the Z-direction of at least 1 cm, or a build size of at least 0.01 m³.

In the present methods, additive manufacturing generally comprises depositing a layer or a bead of a cross-linkable thermosetting component, usually in a continuous or semi-continuous manner. As used herein, the term “depositing” includes applying, spraying, extruding, coating, spreading, or other technique by which a composition or material is positioned in a desired location. A machine may deposit a plurality of beads to form a layer. In some embodiments, an initial layer is deposited on a bed or support, and a subsequent layer is deposited on the initial layer. The initial layer can be deposited in X-Y directions, then the subsequent layer is deposited in the same X-Y directions but at a different location along the z-direction. The initial layer may begin curing before the subsequent layer is deposited on it. This may be a function of the nozzle's rate of movement in the X-Y directions. The initial layer will be at a deposit temperature when it is applied to a support. For a thermosetting material, the temperature will increase as the layer begins curing, since an exothermic curing reaction will release energy, leading to an increase in temperature.

The thermosetting material is deposited and begins to cure and then a next layer of the thermosetting material is applied to the curing layer. The curing layer heats the next layer, raising its temperature as it begins to cure. This transfer of heat from a first layer to a subsequent layer continues as layers are deposited.

Exothermic properties of the present methods and compositions can be characterized by gel time, peak temperature and/or gel to peak time. Peak temperature is generally the highest temperature reached by a sample during curing, or it may be expressed as the difference between that highest point and a temperature when the sample begins curing or is deposited. In some embodiments, the combination of thermosetting material and initiator, along with process parameters are selected to maintain a peak exotherm temperature within a selected range.

The present compositions and methods offer advantages over existing thermosetting technology by reducing cost and complexity, while also being able to accommodate the thermal and physical stresses of additive manufacture of large objects.

An additive manufacturing system or machine for forming an object on a layer-by-layer basis includes a nozzle fluidly connected to a source of a thermosetting component, and a motion control system connected to the nozzle for moving the nozzle in a predetermined pattern to form a layer of the component. In some embodiments, the additive manufacturing system further includes one or more pumps for pumping the thermosetting material (or one or more components of the thermosetting material) to the nozzle. The additive manufacturing system can further include a mixer for receiving and mixing one or more components of the thermosetting material. The system can also comprise a controller for controlling the rate and/or temperature at which the layers of the thermosetting material are deposited. The present methods can comprise the step of changing the temperature of the bead of thermosetting material deposited with a temperature controlling device.

In some embodiments, the rate of depositing the flowable material during additive manufacture is determined based on one or more of the gel time, peak temperature, and time for depositing a layer.

An individual extruded bead is significantly larger (such as about 0.75 inch) than in small-scale additive manufacturing systems. The deposition rate can be at least 10 cm³/h, or at most 50 L/h.

In some embodiments, the present methods allow for manufacturing at atmospheric temperature, outside a chamber or oven that produces an elevated temperature relative to atmospheric. The methods can be done on a heated bed that provides an elevated temperature by contact, without a need to elevate the temperature of surrounding space.

The present methods and compositions enable manufacture of a large object by additive manufacturing, such as by using a thermosetting material, without significant deformation of the object or stresses between layers. As used herein, the term “deformation” refers to an unwanted difference from an intended or desired physical structure or form, and includes warpage, distortion, buckling, curving, or other deformity. In some embodiments, deformation can surprisingly be avoided without the use of shrink additives which are commonly included in thermosetting materials, but rather by reducing or limiting temperature differentials between layers, such as by selecting of cross-linkable components, initiator, and process parameters.

The present compositions include one or more cross-linkable component, such as a vinyl ester component, an unsaturated polyester component, and/or a urethane acrylate component. In some embodiments, the cross-linkable component has a high level of unsaturation.

Unsaturated polyester components are generally condensation products of di- or polycarboxylic acid or anhydride (an acid subcomponent) and a glycol and/or a polyhydric alcohol (an acid subcomponent). Unsaturated polyesters are generally produced from unsaturated di- or polycarboxylic acids or anhydrides, but can optionally include a saturated di- or polycarboxylic acid or anhydride as well. Although high unsaturation generally leads to faster reactivity, it can have a detrimental effect on physical properties, including higher shrinkage during cure. Nonetheless, in some embodiments of the present composition, the unsaturated polyester component has a high level of unsaturation. Such unsaturated polyester components can be produced with a relatively high ratio of unsaturated-to-saturated di- or polycarboxylic acid or anhydride, such as weight or molar ratios of 3:2 or higher, or 2:1 or higher, or 3:1 or higher. In some embodiments, the acid subcomponent of the unsaturated polyester component comprises (1) an unsaturated di- or polycarboxylic acid or anhydride selected from the group consisting of maleic acid or anhydride, fumaric acid, citraconic acid, itaconic acid, glutaconic acid, and mixtures thereof, and (2) a saturated di- or polycarboxylic acid or anhydride selected from the group consisting of phthalic acid and anhydride, isophthalic acid, terephthalic acid, tetrahydrophthalic anhydride, cyclohexane dicarboxylic acid, succinic anhydride, adipic acid, sebacic acid, azelaic acid, malonic acid, alkenyl succinic acids such as n-dodecenyl succinic acid, dodecylsuccinic acid, octadecenyl succinic acid, and anhydrides thereof, and mixtures thereof. In some embodiments, the acid subcomponent of the unsaturated polyester component comprises (1) an unsaturated di- or polycarboxylic acid or anhydride selected from the group consisting of maleic acid or anhydride, fumaric acid and mixtures thereof, and (2) a saturated di- or polycarboxylic acid or anhydride selected from the group consisting of phthalic acid and anhydride, isophthalic acid, terephthalic acid, tetrahydrophthalic anhydride, and mixtures thereof. In some embodiments, the level of unsaturation of the unsaturated polyester component is at least 2.5 moles/kg, or at least 3 moles/kg, or at least 4 moles/kg.

In some embodiments, unsaturation of the thermosetting component of the present compositions is increased by increasing the amount of unsaturated di- or polycarboxylic acids into the unsaturated polyester component. In other embodiments, unsaturation of the thermosetting component is raised by reducing the amount of one or more components that lacks ethylenic unsaturation.

Examples of di- or polyfunctional organic acid or anhydride include, but are not limited to, maleic acid and anhydride, fumaric acid, citraconic acid, itaconic acid, glutaconic acid, phthalic acid and anhydride, isophthalic acid, terephthalic acid, tetrahydrophthalic anhydride, cyclohexane dicarboxylic acid, succinic anhydride, adipic acid, sebacic acid, azelaic acid, malonic acid, alkenyl succinic acids such as n-dodecenyl succinic acid, dodecylsuccinic acid, octadecenyl succinic acid, and anhydrides thereof. Lower alkyl esters of any of the above may also be employed. Mixtures of any of the above are suitable, without limitation intended by this.

Additionally, polyfunctional acids or anhydrides thereof having not less than three carboxylic acid groups may be employed. Such compounds include 1,2,4-benzenetricarboxylic acid, 1,3,5-benzene tricarboxylic acid, 1,2,4-cyclohexane tricarboxylic acid, 2,5,7-naphthalene tricarboxylic acid, 1,2,4-naphthalene tricarboxylic acid, 1,3,4-butane tricarboxylic acid, 1,2,5-hexane tricarboxylic acid, 1,3-dicarboxyl-2-methyl-2-carboxymethylpropane, tetra(carboxy-methyl)methane, 1,2,7,8-octane tetracarboxylic acid, citric acid, and mixtures thereof.

Suitable di- and polyhydric alcohols which may be used in forming the unsaturated polyester component include, but are not limited to, ethylene glycol, diethylene glycol, propylene glycol, dipropylene glycol, 1,3-butanediol, 1,4-butanediol, 1,3-hexanediol, neopentyl glycol, 2-methyl-1,3-pentanediol, 1,3-butylene glycol, 1,6-hexanediol, hydrogenated bisphenol A, cyclohexane dimethanol, 1,4-cyclohexanol, ethylene oxide adducts of bisphenols, propylene oxide adducts of bisphenols, sorbitol, 1,2,3,6-hexatetrol, 1,4-sorbitan, pentaerythritol, dipentaerythritol, tripentaerythritol, sucrose, 1,2,4-butanetriol, 1,2,5-pentanetriol, glycerol, 2-methyl-propanetriol, 2-methyl-1,2,4-butanetriol, trimethylol ethane, trimethylol propane, and 1,3,5-trihydroxyethyl benzene. Mixtures of any of the above alcohols may be used.

In some embodiments, the thermosetting material comprises an unsaturated polyester component has a total acid number equal to or greater than 15.0 mg KOH/g, or at least 16 mg KOH/g, or at least 18 mg KOH/g; in some embodiments, the total acid number is at most about 25 mg KOH/g, or at most about 21 mg KOH/g; it is expressly contemplated that any of the foregoing minimums and maximums can be combined to form a selected range.

Vinyl ester components are produced by the ring opening of an epoxy resin with an unsaturated monocarboxylic acid. In some embodiments, the vinyl ester component is prepared by the reaction between the vinyl containing organic acid such as methacrylic acid and an epoxide containing intermediate in the presence of a catalyst. In some embodiments, the vinyl ester resin is produced from the diglycidyl ether of bisphenol-A (DGEBA) and methacrylic acid, or from a reaction between glycidyl methacrylate with a multi-functional phenol. Any number of epoxide(s) can be used for the invention. Preferably the polyepoxide(s) include but are not limited to glycidyl methacrylate, glycidyl polyethers of both polyhydric alcohols and polyhydric phenols, bisphenol A epoxy, bisphenol F epoxy, glycidyl ester of neodecanoic acid, flame retardant epoxy resins based on tetrabromo bisphenol A, epoxy novolacs, epoxidized fatty acids or drying oil acids, epoxidized diolefins, epoxidized unsaturated acid esters as well as epoxidized unsaturated polyesters. Mixtures of the above may be employed. The polyepoxides may be monomeric or polymeric. Particularly preferred polyepoxides are glycidyl ethers of polyhydric alcohols or polyhydric phenols having equivalent weights per epoxide groups ranging from about 150 to about 1500, more preferably from about 150 to about 1000. Typically, the epoxy resin is based on bisphenol A (equivalent weight 180-500) and the monocarboxylic acid is methacrylic acid. Acrylic acid and derivatives can also be used. Novolac epoxy and blends of novolac and bisphenol A epoxies can also be used. Typically, the constituents are reacted in the ratio of 1 equivalent epoxy resin to 1 mole acid. An example of vinyl ester is bisphenol A glycidyl methacrylate, obtained by reacting bisphenol A epoxy resin with methacrylic acid.

In some embodiments, the present compositions comprise a toughened vinyl ester resin, such as a core shell rubber-modified vinyl ester resin, or a vinyl ester resin containing polybutadiene. As used herein, a “core shell rubber-modified vinyl ester resin” means a vinyl ester resin and a core shell polymer, wherein a core shell polymer having a rubbery core is dispersed throughout the vinyl ester resin. Suitable vinyl ester resins include the vinyl ester components set forth above.

Core shell polymers are generally produced by controlled emulsion polymerization during which the composition of the monomer feed is changed in order to achieve a desired compositional variation over the structure of the core shell polymer. While many core shell polymers having a variety of properties are available, the core shell polymers suitable for use in the present composition typically have a core which is rubbery at ambient conditions and is produced by polymerizing such monomers as butadiene and alkyl acrylates. By “rubbery at ambient conditions” it will be understood that the core of the core shell polymer has a Tg which is lower than the ambient temperature. Preferred core shell polymers include, but are not limited to, polymerized versions of: butadiene; butadiene and styrene; butadiene, methyl methacrylate and styrene; butadiene, alkyl methacrylate, and alkyl acrylate; butadiene, styrene, alkyl acrylate, alkyl methacrylate and methacrylic acid; butadiene, styrene, alkyl acrylate, alkyl methacrylate, methacrylic acid and low molecular weight polyethylene (as flow modifier); butyl acrylate and methyl methacrylate; alkyl methacrylate, butadiene and styrene; alkyl acrylate, alkyl methacrylate and glycidylmethacrylate; and alkylacrylate and alkylmethacrylate. The core shell polymer may comprise an average diameter of 50 to 350 nm; alternatively, 100 to 300 nm; alternatively, 150 to 250 nm; alternatively, about 200 nm; or alternatively, 200 nm. Exemplary core shell polymers for use in the present composition are those which incorporate butadiene as a core component and poly(methyl methacrylate) (PMMA) as a shell component. The core shell polymer may be amine terminated butadiene nitrile rubber (ATBN) nanoparticles.

In some embodiments, the present compositions comprise a reactive impact modifier component. Impact modifiers are additives that improve the impact strength of materials. The impact modifier may improve the impact strength of the additive manufactured product produced from the bead or particle by at least 10%, such as at least 20% or 30% compared to one not containing the impact modifier. Typically, the improved impact strength as defined above is measured by notched Izod impact strength according to the method described in ASTM D256 or ISO180.

In impact modified polymer beads of the present disclosure, the impact modifier may form elastomeric regions in the bead. Specifically, in the case of core-shell impact modified beads, the impact modifier may form discrete elastomeric phases in the bead and the acrylic or vinyl (co)polymer matrix forms a continuous phase in the bead. Still further, in addition or alternatively to forming elastomeric regions itself, the impact modifier may be polymerized into the acrylic or vinyl (co)polymer to form elastomeric regions in the polymer chains. Even further the impact modifier may crosslink the matrix (co)polymer and provide elastomeric regions in the resulting network or form branches off the matrix (co)polymer. Suitable impact modifiers of the aspects of the present invention are those known to one of ordinary skill in the art, and include, but are not limited to, core-shell, oligomers, reactive oligomers and (co)polymers. Suitable impact modifiers may include random, block, radial block, dendrimer, branched and/or graft polymer types.

In some embodiments, the impact modifiers are selected from acrylic (such as n-butyl acrylate-styrene), styrene (such as MBS and SBR), silicone (including silicone-acrylic), nitrile rubber, isoprene, butadiene, isobutylene and aliphatic polyurethane, polyether oligomer, polyester oligomer modifiers. Typically, the impact modifier can be an acrylic, butadiene, aliphatic polyurethane or silicone-acrylic impact modifier.

In some embodiments, the present compositions comprise a urethane acrylate component. As used herein, “urethane acrylate” means a reaction product of diisocyanate, an —OH functional molecule with a cross-linkable olefinic double bond, and optional mono-, di-, or multifunctional —OH containing material. As used herein “diisocyanates” means any type of aromatic, aliphatic, alicyclic and aromatic-aliphatic polyisocyanates, two or more isocyanate groups on each molecule; including dimers and trimers. Exemplary aromatic polyisocyanates include diphenylmethane diisocyanate (MDI) and toluene diisocyanate (TDI). Exemplary aliphatic polyisocyanates include hexamethylene diisocyanate (HDI) and isophorone diisocyanate (IPDI). The “—OH functional molecule with cross-linkable olefinic double bond” may include partial esters of polyhydric alcohols with acrylic acid or methacrylic acid, such as, for example, ethylene glycol monoacrylate or monomethylacrylate, 1,2- or 1,3-propanediol monoacrylate or monomethylacrylate, 1,4-butanediol monoacrylate or monomethyacrylate, 1,6-hexanediol monoacrylate or monomethacrylate, trimethylolpropane diacrylate, glycerol diacrylate, pentaertythritol triacrylate and the mono(N-methylolacrylamide)-ethers and mono-(N-methylolmethacrylamide)-ethers of ethylene glycol, propylene glycol, butanediol, hexanediol and neopentyl glycol. The “mono, di, or multifunctional OH containing material” may include polyfunctional alcohols, such as diols of 2 to 8 carbon atoms, for example ethylene glycol, propanediols, butanediols, pentanediols, hexanediols, triols, such as, for example, glycerol, trimethylolpropane and hexanetriols, pentaertythritol and the like; or polyether-polyols prepared by reaction of 1 molecule of alcohol with from 1 to 50, preferably 15 to 30 molecules, molecules of ethylene oxide or propylene oxide. Polyester polyols can include the reaction product of polycondensation of polybasic acids, such as adipic acid, succinic acid, azelaic acid, sebacic acid, phthalic acid, isophthalic acid and terephthalic acid, with polyhydric alcohols, such as 1,4-butanediol, 1,3-butanediol, ethylene glycol, diethylene glycol, propylene glycol, 1,2-propylene glycol, dipropylene glycol, 1,6-hexaneglycol and neopentyl glycol.

The present composition may further comprise one or more additives such as air release agents, wetting/dispersing agents, rheology additives, thixotropic agents, inhibitors (including but not limited to quinone inhibitors), initiators, catalysts, accelerators, drier stabilizers, surfactants, dyes, talc and fillers. Suitable wetting and dispersing agents include a solution of a salt of unsaturated polyamine amides and acidic polyesters. Suitable rheology additives include polyhydroxycarboxylic acid amides, organophilic phyllosilicates, and castor oil derivatives. Silicone-free polymer-based air release additive.

The present composition may comprise more than one additive of the same type (e.g., one or more fillers) or a combination of additives of different types (e.g., at least one accelerator and at least one inhibitor). When present, the one or more additives may comprise about 0.1 to about 60%; alternatively, about 0.1 to 50%; alternatively, about 0.1 to 40%; alternatively, about 0.1 to 20%, or alternatively, about 0.1 to 15% of the total weight of the present composition.

In some embodiments, the compositions and methods are used to make a cured object having a selected coefficient of linear thermal expansion (CLTE) in a temperature range of 0° C. to 160° C. of 10 um/m-° C. or less in X- and/or Y-directions, and/or 100 um/m-° C. or less in a Z-direction. “um” is an abbreviation for micron or micrometer. In some embodiments, the compositions and methods are used to make a cured object having a selected coefficient of linear thermal expansion (CLTE) over a temperature range of 20° C. to 97° C. of 10 um/m-° C. or less, alternatively 5 um/m-° C. or less, alternatively 3 um/m-° C. or less, in X- and/or Y-directions. In some embodiments, the cured object having the foregoing CLTE values is produced by additive manufacturing by depositing 2, 3, 5, 7, 8, 10, 12, 15, 20, 25, 30, 40, 50, 60, 70, 100 or more layers to form the object.

In some embodiments, the object exhibits less than about 1%, or less than about 0.5%, or less than 0.30% volumetric change when thermocycled between 25-65° C., 25-100° C., 25 and 125° C., or between 25 and 150° C., or between 25 and 177° C. and/or when cooled from 177° C. to 25° C., or from 150° C. to 25° C., or from 125° C. to 25° C., or from 100° C. to 25 C, or from 65° C. to 25° C. In some embodiments, the object exhibits less than 5%, or less than 3%, or less than 2% (by volume) of voids.

The present compositions also comprise a low profile additive. It is known that curable compositions tend to shrink when they cure. Shrinkage is generally proportional to the number of crosslinking reactions, or the extent of cure that occurs.

For some curable compositions, this tendency can be lessened or overcome by adding low profile additives (often abbreviated to LPAs). LPAs have been used in various radical polymerizable unsaturated resins to reduce volume changes in parts cured by free radical polymerization of reactive olefinic bonds. LPAs are typically non-reactive amorphous polymers, such as polystyrene, styrene-butadiene rubber and the like. A common consideration for LPAs in thermosetting resins is their phase separation, which refers to how the LPA will kick out of solution in the resins as the cross-linking occurs. In other words, the solubility of LPAs in the thermosetting resins is altered as the matrix becomes more crystalline. The selection of an LPA for a thermosetting resin is generally based on multiple criteria, including its solubility, with higher solubility in the compositions being favored. LPAs are typically selected to be soluble in the cross-linkable matrix resin before it is crosslinked, done to achieve shelf-stability; become insoluble as the matrix resin crosslinks exothermically and warms, separating in discrete agglomerations or phases within the cured matrix resin; and phase separate when crosslinking or cure proceeds above a temperature of 120° C. Because of the varying degree of cure typical of additive manufacturing, typical LPA/resin combinations known in the art are not useful or suitable for additive manufacturing.

Curing of a thermosetting material used in additive manufacturing is further complicated because the temperature during material deposition in additive manufacturing may vary widely, with exotherms ranging from 30° C. to about 130° C. Further, the temperature maximums typically vary over the additive manufactured object. In additive manufacturing, the composition should yield a printed object that will retain its dimensions as defined by a CAD file, regardless of size, mass, or geometries. When the dimensions of the manufactured object change during curing the thermosetting composition, the ability to index and mill the object are severely limited. Therefore, a LPA for a thermosetting resin used for additive manufacturing has to function across a wide range of temperatures to be practical since the objects to be printed range in their exotherms.

It has been surprisingly found that including a LPA with low solubility in the thermosetting materials within the present compositions results in low shrinkage at a low matrix temperature. Thermosetting compositions useful for additive manufacturing have other typical properties, such as unusually high viscosity and unusually high thixotropy. Without being bound by theory, it is believed that additive manufacturing compositions require specific rheological properties (namely high viscosity and shear thinning), so the problem of phase separation of the LPA separating from the resin over time is reduced or rendered moot. The LPA becomes essentially locked into the matrix and unable to migrate or stratify.

In some embodiments, the present compositions comprise an LPA that has low solubility or is essentially insoluble in the thermosetting material at room temperature (e.g., about 25° C., or between 22° C. and 28° C.), or in a component of the thermosetting material. Surprisingly, additive manufacturing compositions comprising such LPAs and thermosetting materials produce objects with high dimensional stability and minimum volume change over a wide range of curing temperatures and exotherms.

Exemplary low profile additives (LPAs) are thermoplastic polymers such as, for example, vinyl acetate polymer, acrylic polymer, polyurethane polymer, polystyrene, butadiene styrene copolymer, saturated polyester, polycaprolactone, and the like. These polymers typically have non-reactive end groups, are of high molecular weights (10,000 to 200,000) and are typically supplied in a vinyl monomer such as styrene to reduce the viscosity of the thermoplastic to a workable range. In some embodiments, the low profile additive comprises polyvinyl acetate (PVAc), saturated polyester, PEG-400, PEG-600 Diacrylate, Styrene Butadiene Rubber, functionalized polystyrene, polyethylene, cellulose acetate butyrate (CAB) and mixtures thereof. In some embodiments, the low profile additive comprises a vinyl acetate-vinyl ester copolymer, a vinyl ester-ethylene copolymer, a vinyl acetate isopropenyl acetate copolymer, a vinyl laurate, a vinyl acetate-vinyl laurate copolymer, or a mixture thereof. In some embodiments, the low profile additive comprises vinyl acetate copolymers of 40 to 95 wt % vinyl acetate and 5 to 60 wt % one or more comonomers comprising vinyl esters of unbranched or branched carboxylic acids having 3 to 20 carbon atoms and methacrylic esters and acrylic esters of unbranched or branched alcohols having 2 to 15 carbon atoms. In some embodiments, the LPA is a copolymer of a vinyl acetate, a vinyl ester, an isopropenyl acetate, and one or more other monomers, such as vinyl propionate, vinyl butyrate, vinyl 2-ethylhexanoate, vinyl laurate, vinyl pivalate and vinyl esters of alpha-branched monocarboxylic acids having 5 to 13 carbon atoms. In some embodiments, the low profile additive comprises a vinyl acetate copolymer of vinyl acetate and one or more comonomers from the group consisting of vinyl laurate and vinyl esters of α-branched monocarboxylic acids having 9 to 10 carbon atoms; in some embodiments, such copolymers comprise 55 to 95 wt % of the vinyl acetate and 5 to 45 wt % of the comonomers. In some embodiments, the low profile additive comprises one or more vinyl acetate-isopropenyl acetate copolymers, wherein the vinyl acetate-isopropenyl acetate copolymers are based on from 50 to 98% by weight of vinyl acetate, from 2 to 50% by weight of isopropenyl acetate and optionally one or more further ethylenically unsaturated monomers. Other examples and information regarding LPAs are provided in Zarka et al. US Pat. App. Publication No. 2020/0157341 A1 and Bannwarth et al. US Pat. App. Publication No. 2022/0259344 A1, both of which are incorporated by reference herein.

In some embodiments, the present compositions comprise a low profile additive with low solubility in the thermosetting material, or low solubility in a component of the thermosetting material, for example in an unsaturated polyester component (such as a condensation product of a glycol and maleic acid or anhydride). In some embodiments, the LPA is included in the present compositions at a concentration that exceeds the solubility of the LPA in the thermosetting material or a component thereof. In some embodiments, the present compositions comprise a LPA having a solubility percentage less than about 15%, or less than about 12%, or less than about 10%, in an unsaturated polyester component produced by condensation of a glycol and maleic acid or anhydride. It should be noted although a LPA's solubility percentage is described by reference to its solubility in a condensation product of a glycol and maleic acid or anhydride, it may of course be used in a thermosetting material that does not include a condensation product of a glycol and maleic acid or anhydride.

Solubility percentage of a LPA in a material can be determined by adding the LPA to a desired thermosetting material, such as an unsaturated polyester and vinyl monomer solution, at the selected weight percentage to make a 150 g sample. This sample is housed in a glass jar. Samples are observed at room temperature (e.g., about 25° C., or between 22° C. and 28° C.) over a period of ten days. At the end of this period, the jars are visually inspected for clarity and the presence of two phases. If it is clear and no interface is noted, the LPA at that percentage is soluble in the material, but if it is unclear or particles are visible, the percentage of LPA exceeds the solubility for the material; the solubility percentage is the lowest percentage wherein the LPA exceeds the solubility for the material.

In some embodiments, the LPA has a solubility percentage less than about 30%, or less than about 25%, or less than about 20%, or less than about 15%, or less than about 12%, or less than about 10%, or less than about 5%, or less than about 1%, in the thermosetting material or in a component of the thermosetting material, such as an unsaturated polyester component (such as a condensation product of a glycol and maleic acid or anhydride); additionally, the LPA has a solubility of 0.1% or more, or 0.5% or more, or 1% or more, or 5% or more; any of these minimums and maximums can be combined to form a range (so long as the minimum is less than the maximum). In some embodiments, the LPA is essentially insoluble in the thermosetting material or in a component of the thermosetting material, such as an unsaturated polyester component (such as a condensation product of a glycol and maleic acid or anhydride).

In some embodiments, the present compositions comprise at least about 3%, 4%, 5%, 7%, 10%, 12%, 15%, 18%, 20%, 25%, or more of the low profile additive. In some embodiments, the present compositions comprise at most about 50%, 40%, 35%, 30%, 25%, 22%, 20%, 18%, 15%, or less of the low profile additive. Any of these minimums and maximums can be combined to form a range (so long as the minimum is less than the maximum). The foregoing percentages are weight percentages based on the weight of the low profile additive over the total weight of the composition. When the low profile additive is provided in a mixture (such as in a mixture comprising 50% styrene), the weight of the low profile additive itself (not including styrene or other components in the mixture) is used to calculate its percentage in the composition.

The present composition may further comprise one or more ethylenically unsaturated monomers. The ethylenically unsaturated monomer can be any ethylenically unsaturated monomer capable of crosslinking the unsaturated polyester component or vinyl ester component via vinyl addition polymerization. Exemplary monomers include, but are not limited to styrene, methyl methacrylate, vinyl toluene, hydroxy methyl methacrylate, hydroxy methyl acrylate, hydroxy ethyl methacrylate, hydroxy ethyl acrylate, hydroxy propyl acrylate, hydroxy propyl methacrylate, alpha methyl styrene, and divinyl benzene. Further exemplary monomers include o-methyl styrene, m-methyl styrene, p-methyl styrene, methyl acrylate, t-butylstyrene, diallyl phthalate, triallyl cyanurate, trimethylolpropane triacrylate, trimethylolpropane trimethacrylate; ethoxylated trimethylolpropane triacrylate; glyceryl propoxy triacrylate; propylene glycol diacrylate; ethylene glycol diacrylate; ethylene glycol dimethacrylate; ethylene glycol diacrylate; tetraethylene glycol diacrylate; triethylene glycol dimethacrylate; tripropylene glycol dimethacrylate; polypropylene glycol diacrylate; polyethylene glycol dimeacrylate; butanediol diacrylate; butane-diol dimethacrylate; pentaerythlitol triacrylate; pentaerythritol tetra-acrylate; ethoxylated bisphenol A diacrylate; hexane diol diacrylate; dipentaerythritol monohydroxypentaacrylate; neopentyl glycol diacrylate; neopentyl glycol dimethacrylate; and tris(2-hydroxyethyl)isocyanurate triacrylate, and mixtures of two or more of the foregoing monomers. In some embodiments, the monomer is styrene or one of its derivatives. In other embodiments, the composition is substantially free of styrene and/or any of its derivatives. The monomer may comprise 0.1 to about 60%; alternatively, 1 to 40%; alternatively, 5 to 30%; or alternatively 10 to 20% of the total weight of the present composition.

The additive manufacturing compositions should have a sufficiently high viscosity so that the LPA dispersions are shelf-stable or do not exhibit phase separation for a desired stability period. In some embodiments, the compositions have a viscosity of at least about 1,000,000 cps, alternatively at least about 1,200,000 cps, or at least about 1,300,000 cps, or at least about 2,000,000 cps; in some embodiments, the compositions have a viscosity of at most about 20,000,000 cps, or at most about 10,000,000 cps, or at most about 5,000,000 cps; it is expressly contemplated that any of the foregoing minimums and maximums can be combined to form a selected range. In the present disclosure, when viscosity is discussed, it refers to viscosity measured using HBT Spindle 95 @ 10 rpm, at a temperature of 25C. The SI unit for dynamic viscosity is the Poiseuille (Pa·s), where 1 centipoise (cps) is equivalent to 1 mPa·s. The desired stability period can be at least one day, or at least seven days, or at least one month.

The additive manufacturing compositions should have a sufficiently high thixotropic index so that they can be pumped and applied via a 3D printer. In some embodiments, the compositions have a thixotropic index of at least about 5, alternatively at least 5.1; in some embodiments, the compositions have a thixotropic index of at most about 10, or at most about 8, or at most about 6; it is expressly contemplated that any of the foregoing minimums and maximums can be combined to form a selected range. In the present disclosure, when thixotropic index is discussed, it refers to thixotropic index measured by dividing the viscosity at 1 rpm by the viscosity at 10 rpm.

It has been found that a first thermosetting material with high unsaturation (100%) and a high acid number can be blended with a second (or multiple) thermosetting resin such that the net unsaturation of the thermosetting material is greater than 50%, and the LPA could control shrinkage at curing temperatures as low as 52° C. An important consideration for controlling the solubility of the LPA in the resin blend was the acid number of the 100% unsaturated resin. When the acid number ranged from 18-21, excellent shrinkage control was observed, indicating that an acid number of at least about 18 was desirable. When using a similar resin with an acid number of 6-14, the solubility in the resin was greatly improved but the exotherm needed to control shrinkage was increased. Smaller printed parts may not achieve the minimum exotherm. It was also found that a combination of LPA and highly unsaturated polyester wherein the LPA's solubility percentage in a condensation product of glycol and maleic acid/anhydride was 5-10% had desirable shrinkage control.

In some embodiments, the additive manufacturing compositions have a viscosity of at least about 1,000,000 cps, alternatively at least about 1,200,000 cps, or at least about 1,300,000 cps, and/or a thixotropic index of at least about 5, alternatively at least 5.1; and/or a thermosetting material comprising an unsaturated polyester component equal to or greater than 15.0 mg KOH/g, or at least 16 mg KOH/g, or at least 18 mg KOH/g; and/or a thermosetting material having at least 50% unsaturation.

The present composition may comprise a multi-part composition where each part is prepared separately and then combined prior to use. In these embodiments, the present composition comprises a first part comprising the crosslinkable component; and a second part comprising an initiator. The present composition may optionally further comprise a third part comprising a monomer or other components.

The present composition may comprise a multi-part composition where each part is prepared separately and then combined prior to or during deposition. In some embodiments, the present composition comprises a first part comprising a cross-linkable component (which may be a second portion of the same cross-linkable component contained in the first part, or a different one) and an accelerator; and a second part comprising the cross-linkable component and an initiator. In such multi-part compositions, it is desirable that the first part is free of the initiator and the second part is free of the accelerator, so that cross-linking is avoided or minimized prior to combining the first and second parts. In some embodiments, the first part and the second part are provided or mixed at ratios of about 1:1, or about 2:1, or about 10:1, or about 20:1, or about 50:1, or another ratio.

The present compositions can comprise an accelerator comprising copper containing complexes; quaternary ammonium or phosphonium salts; tertiary amines or phosphines; and/or optionally transition metal salts, as disclosed in Nava U.S. Pat. App. Publication No. 20160096918. In some embodiments, the accelerator comprises a component selected from cobalt naphthenate, cobalt octoate, cobalt hydroxide, potassium octoate, potassium naphthenate, a manganese salt, an iron salt, N,N-dimethylaniline, N,N-dimethyl-p-toluidine; or a combination thereof.

The present compositions or its parts may further comprise one or more additives. Suitable additives include inhibitors, antioxidants, rheology modifiers, air release/wetting agents, coloring agents, air release agents, inorganic or organic fillers, light weight fillers, surfactants, inorganic or organic nanoparticles, or combinations thereof. In some embodiments, the composition comprises an inhibitor selected from t-butyl catechol, 4-Hydroxy TEMPO (4-hydroxy-2,2,6,6-tetramethylpiperidin-1-oxyl), hydroquinone, methyl hydroquinone or para-benzoquinone, monomethyl ether of hydroquinone, and triphenyl antimony; 1,4-naphthoquinone, or a combination thereof.

In some embodiments, the additive manufacturing compositions comprise a rheology modifier, which may be selected from silica, clay, organo-treated clay, castor oil, and a polyamide; or a combination thereof. In some embodiments, the air release/wetting agent is selected from polyacrylate, silicone, and mineral oil; or a combination thereof. In some embodiments, the coloring agent is selected from iron oxide, carbon black, and titanium oxide; or a combination thereof. In some embodiments, the filler comprises an organic or inorganic filler, such as an organic filler selected from polyethylene, a crosslinked polyester, a crosslinked acrylic, a crosslinked urethane, abs, graphite, and carbon fibers; or a combination thereof; or inorganic filler selected from calcium carbonate, clay, talc, wollastonite, fly ash, glass or polymeric microballoons, zinc sulfate, nano clay, nano silica, nano zinc, and glass fibers; or a combination thereof.

The term “initiator” generally includes compounds that may be referred to catalysts, curing agents, hardeners or by other terms in the polymer industry, though certain contexts may indicate a different meaning for one or more of those terms.

In addition to the initiator, curing of the present composition can be facilitated using an organometallic compound, UV, electron beam, heat or peroxide systems. In some embodiments, curing is performed using UV light, an electron beam, an organometallic compound, a peroxide, or heat. In some embodiments, the curing is performed in an open or unheated environment, that is, outside an oven or other heating chamber. The open environment may include a bed on which the thermosetting material is deposited, where the bed is heated but the surrounding environment is not heated for the purpose of curing and is at ordinary room temperature (e.g., about 25° C., or between 22° C. and 28° C.). In some embodiments, the thermosetting material is deposited onto a bed, and the material exiting a nozzle has a temperature between 15 and 30° C., and the bed has a temperature between 15 and 30° C.

In some embodiments, where a peroxide system is employed as the initiator, the peroxide system may be a peroxide or hydroperoxide, preferably at concentrations from 0.5 to 4% by weight. Exemplary peroxides or hydroperoxides include, but are not limited to, benzoyl peroxide, lauroyl peroxide, cumene hydroperoxide, t-butyl hydroperoxide, methyl ethyl ketone peroxide (MEKP), t-butyl perbenzoate, and the like. In some embodiments, the initiator comprises a peroxide selected from cumene hydroperoxide, benzoyl peroxide, or blends of cumene hydroperoxide and methyl ethyl ketone peroxide. For example, the initiator can be cumene hydroperoxide.

In some embodiments, the composition comprises an initiator that initiates crosslinking at a slower rate and/or at a lower exotherm. For instance, the initiator may comprise cumene hydroperoxide or benzoyl peroxide. In some embodiments, the initiator comprises a combination of MEKP and another peroxide, such as a combination of MEKP and CHP. In some embodiments, the initiator does not comprise MEKP. The initiator composition may be a combination of an initiator, a catalyst such as a metal salt or complex, and/or other components that initiates crosslinking at a slower rate and/or at a lower peak exotherm. In some embodiments, the initiator is adapted so that the composition during curing does not exceed 9.0 J/g-min, alternatively 8.0 J/g-min, alternatively 7.1 J/g-min, alternatively 6.0 J/g-min.

Types of initiators that work at room temperature and could be used in the present compositions and methods include:
a. organic peroxides such as cumene hydroperoxide (CHP), benzoyl peroxide (BPO), blends of cumene hydroperoxide and methyl ethyl ketone peroxide (MEKP), peroxy(di)carbonate, peroxyesters, diacylperoxides, peroxyketals, dialkyl peroxides, and hydroperoxides; and inorganic peroxides, Ammonium persulfate, Hydroxymethanesulfinic acid monosodium salt dihydrate, Potassium persulfate, or Sodium persulfate. For example, the peroxide can be BPO, CHP, or a blend of CHP and MEKP.
b. photo initiators such as benzoin ethers, benzyl ketals, alpha-dialkoxyacetophenones, alpha-hydroxyalkylphenones, alpha-aminoalkylphenones, acylphosphine oxides, benzophenones/amines, thio-xanthones/amines, and titanocenes;
c. azo initiators such as 4,4′-Azobis(4-cyanovaleric acid), 1,1′-Azobis(cyclohexanecarbonitrile), Azobisisobutyronitrile; 2,2′-Azobis(2-methylpropionitrile).

The additive manufacturing compositions can also comprise a reinforcing material such as synthetic or natural fibers. Polymer composite materials often are a combination of small fibers (glass, carbon, aramid) and a thermosetting resin such as unsaturated polyester, epoxy, phenolic, polyimide, polyurethane and others. Thermosetting resins can be reinforced with glass fibers, carbon fibers, aramid fibers, basalt fibers (geotextile fibers) or natural fibers. For example, the reinforcing material can be a continuous fiber extruded with the thermosetting material or discontinuous fibers that are distributed in the thermosetting material, such as discontinuous fibers selected from the group of materials consisting of carbon, glass, and aramid. The reinforcement can be a mixture of two or more of the above reinforcement materials.

In some embodiments, the present compositions comprise reinforcing material as at least 10% of the total composition, alternatively at least 15%, or 20%, or 25%, or 30%, or 35%, or 40%, or more.

Thermosetting materials undergo curing, which is an exothermic, irreversible chemical reaction in which the low molecular weight liquid converts to a high molecular weight, cross-linked solid. An intermediate change during curing is gelation, when the reaction has proceeded sufficiently so that the thermosetting material has achieved a flexible but non-flowing three-dimensional molecular structure. Gelation is accompanied by a release of energy, resulting in a temperature rise. The material is no longer liquid or flowable. Thus, gel time is a factor in the manufacture of all composites and gel temperature is important for thick or large cross section composites. In some embodiments, the gel time range of the present compositions is 10-60 min. The gel to peak time is 35-80 min.

The average thickness of the additive manufacturing composition applied by the additive manufacturing system may range from 1.27 to 127 mm; alternatively, 2.54 to 63.5 mm; alternatively, 3.81 to 25.4 mm; alternatively, 5.08 to 20.32 mm; alternatively, 5.08 to 19.05 mm; alternatively, 5.08 to 15.24 mm; or alternatively; about 6.35 mm; or alternatively, 6.35 mm to achieve the performance noted herein. In some embodiments, the thermosetting material is deposited in an amount sufficient to achieve a layer with a thickness of 0.1016 to 0.254 mm, preferably 0.1524 to 0.127 mm. Furthermore, in some embodiments, the present composition may be applied as a layer in a single or a series of applications to achieve a layer in the range of 0.1016 to 25.4 mm, preferably 0.1524 to 2.032 mm.

In some embodiments, the present methods and compositions are employed to manufacture a substrate, as opposed to a coating on a substrate. The cured composition shows no or minimal evidence of dimensional changes such as warping. One skilled in the art would readily appreciate what no or minimal evidence of dimensional changes represents. A cured composition without substantial deformation may still have some deformation without having unacceptable deformation. For example, acceptable deformation encompasses deformation of 0.25 inch or less from a plane of printing or depositing, alternatively 1 cm or less, alternatively 0.5 cm or less. As another example, no or minimal evidence of dimensional changes represents a finished product with less than 0.10 mm warping on a 914.4 mm (L)×228.6 mm (H)×19.05 mm (W) part. In some embodiments, the present compositions, when cured, display less than 5% deformation, alternatively less than 2.5% deformation, alternatively less than 1% deformation, from a plane of printing or depositing.

The present methods and compositions can be employed to make objects of any shape, size, or use. Preferably, the object is a polymer composite article. Examples of objects that can be made via large-scale additive manufacturing methods disclosed herein include molds, prototypes, support beams, furniture, core structures, and other objects.

It is also contemplated that the present thermosetting compositions may be used in any number of different ways and in different applications not necessarily involving objects made by additive manufacturing. In particular, the present compositions can be used for other applications where dimensional stability at high temperatures is desired. The thermosetting compositions may used for injection molding, vacuum molding, casting, extrusion, or roll coating techniques (gravure, reverse roll, etc.).

The present compositions can be used in an extrusion molding method, a blow molding method, a compression molding method, a vacuum molding method, an injection molding method, or the like. To form a film, the present compositions can be used in a melt extrusion method or a solution casting method. When using a melt-molding method, examples include inflation film molding, cast molding, extrusion lamination molding, calender molding, sheet molding, fiber molding, blow molding, injection molding, rotary molding, and cover molding. In some embodiments, the thermosetting composition is used to form a prepreg. Other uses of the present compositions include RTM (Resin Transfer Molding), VaRTM (Vacuum assist Resin Transfer Molding), lamination molding, and hand lay-up molding.

Alternatively, the composition may be applied to a substrate by curtain coating, slot-die coating, wire-wound rod coating, gravure coating, roll coating, knife coating, or melt coating. The composition may be applied as either a continuous or discontinuous coating or film or layer or sprayed through different nozzle and/or head configurations at different speeds using typical application equipment. The application may be followed by drying or heat treatment.

In another embodiment, the curable composition is a laminating adhesive for flexible packaging. The curing temperature for such an adhesive is desirably a low temperature ranging from room temperature (e.g., about 25° C., or between 22° C. and 28° C.) to about 50° C.

In some embodiments, the objects produced by curing the present compositions have one or more desired properties, in addition to dimensional stability. More particularly, in some embodiments, objects have a flexural PK or strength of 1 ksi or higher, alternatively 3 ksi or higher; a flexural modulus of 200 ksi or higher, alternatively 400 ksi or higher; a tensile PK or strength of 1 ksi or higher, alternatively 2 ksi or higher; a tensile modulus of 100 ksi or higher, alternatively 200 ksi or higher; a tensile elongation of 3% or less, alternatively 2% or less; a compression PK or strength of 3 ksi or higher, alternatively 4.5 ksi or higher; a compression modulus of 200 ksi or higher, alternatively 300 ksi or higher; a DMA Tan Delta, Tg of 200° C. or less, alternatively 175° C. or less. It is expressly contemplated that any or all of the foregoing properties can be combined with the CLTE values described herein to define an object having desirable properties.

While specific embodiments have been described in detail, it will be appreciated by those skilled in the art that various modifications and alternatives to those details could be developed considering the overall teachings of the disclosure.

### EXAMPLES

### Example 1

In this example, compositions are prepared with the components and steps set forth in Table 1. More particularly, each composition comprises a crosslinkable component (a vinyl ester and/or an unsaturated polyester, and a monomer), a cobalt accelerator and an amine.

TABLE 1

| Components | Ex. 1A | Ex. 1B | Ex. 1C | Ex. 1D | Ex. 1E | Ex 1F |
|---|---|---|---|---|---|---|
| Epoxy novolac vinyl ester resin | | 48.80% | | | | |
| Unsaturated polyester resin¹ | | | 22.43% | | | 33.52% |
| Toughened vinyl ester resin A | 58.4% | 8.62% | | 47.44% | | |
| Toughened vinyl ester resin B | | | 14.95% | | 68.08% | 22.75% |
| Quinone inhibitor A | 0.01% | 0.01% | 0.05% | 0.01% | 0.0074% | 0.03% |
| Inhibitor | | 0.01% | | 0.01% | 0.011% | |
| Quinone inhibitor B² | | | 0.01% | | | |
| Quinone inhibitor C³ | | | 0.03% | | | |
| wetting and dispersing additive⁴ | 0.39% | 0.39% | 0.24% | 0.32% | 0.45% | |
| rheology additive⁵ | 0.29% | 1.45% | 0.18% | 1.20% | 0.34% | 0.28% |
| silicone-free polymer-based air | 0.28% | 0.28% | 0.24% | 0.23% | 0.33% | 0.37% |
| release additive | | | | | | |
| accelerator (cobalt salt)⁶ | 0.30% | 0.32% | 0.19% | 0.32% | 0.37% | 0.21% |
| drier stabilizer⁷ | 0.07% | 0.08% | 0.05% | 0.08% | 0.092% | 0.06% |
| accelerator (cobalt salt) | | | | 0.02% | 0.028% | |
| tertiary amine A | 0.09% | | 0.06% | 0.09% | 0.11% | 0.07% |
| tertiary amine B | 0.06% | 0.22% | 0.04% | 0.08% | 0.074% | 0.05% |
| dye | | | | | 0.004% | |
| Low-profile additive⁸ | | | 30% | | | |
| Low-profile additive⁹ | | | | | | 15.0% |
| carbon reinforcing fiber⁷¹⁰ | | 32.92% | 30% | 27.20% | | |
| glass reinforcing spheres | | | | 5.78% | | |
| carbon reinforcing fiber¹¹ | 29.9% | | | | | |
| talc | 6.4% | | | | 15.00% | |
| glass reinforcing fiber | | | | | 5.00% | |
| rheology additive (organophilic | 1.28% | 1.38% | 1.13% | 1.14% | 1.50% | 2.0% |
| phyllosilicates) | | | | | | |
| rheology additive (castor oil | 2.56% | 1.64% | 1.50% | 1.54% | 4.50% | 1.26% |
| derivative) | | | | | | |
| ethylenically unsaturated monomer¹¹ | | 3.88% | | 14.54% | 4.21% | |
| ethylenically unsaturated monomer¹² | | | | | | 4.0% |

¹Condensation product of propylene glycol and maleic anhydride.
²(12%) so multiply mass by 8.3
³(10%) so multiply mass by 10
⁴solution of a salt of unsaturated polyamine amides and acidic polyesters
⁵solution of polyhydroxycarboxylic acid amides
⁶12% cobalt dodecanoate
⁷21% cobalt dodecanoate
⁸50% LPA (Wacker RT50) solution in styrene monomer
⁹100% LPA (Wacker RT50) non-diluted
¹⁰150 um
¹¹Graphite
¹²Styrene monomer
¹³ Alpha-methyl styrene

### Example 2

In this example, the compositions of Example 1 are combined with a second part comprising cumene hydroperoxide (CHP). The compositions of Table 1 can be combined with an initiator to form additive manufacturing composition and initiate curing of the composition.

TABLE 2

| | 2A | 2B | 2C | 2D | 2E | 2F |
|---|---|---|---|---|---|---|
| first part | 1A | 1B | 1C | 1D | 1E | 1F |
| second part | CHP | CHP | MEKP- | CHP | CHP | 1:1 |
| | | | 925H | | | CHP/MEKP- |
| | | | | | | 925H |

### Example 3

In this example, the compositions of Examples 2A to 2F were evaluated in a large-area additive manufacturing machine at Oak Ridge National Laboratory to make objects. The crosslinkable component and initiator component were combined in a mixer of the additive manufacturing system and fed to a nozzle. The objects were formed by depositing a series of layers.

### Example 4

In this example, the Coefficient of Linear Thermal Expansion (CLTE often referred to as “α”) for the objects made in Example 3 were measured. CLTE is a material property which characterizes the dimensional stability under the effect of temperature elevation. The CLTE or alpha of a material is calculated by dividing the linear expansion per unit length by the change in temperature, as shown by the following formula:

α=ΔL/(L0*ΔT)

where α is the coefficient of linear thermal expansion per degree Celsius; ΔL is the change in length of test specimen due to heating or to cooling; L0 is the original length of specimen at room temperature; and ΔT is the temperature change, ° C., measured during the test.

The measurements were made using a TA Q400 instrument at 3° C./min with 0.05N force. CLTE measurement can be performed using a specific temperature range to compare its effect on the stability of many materials. For thermosetting, a typical temperature range is 0-160° C., whereas a typical temperature range for thermoplastics is 20-97° C. Determinations made at the temperature ranges of 0-160° C. and 20-97° C.

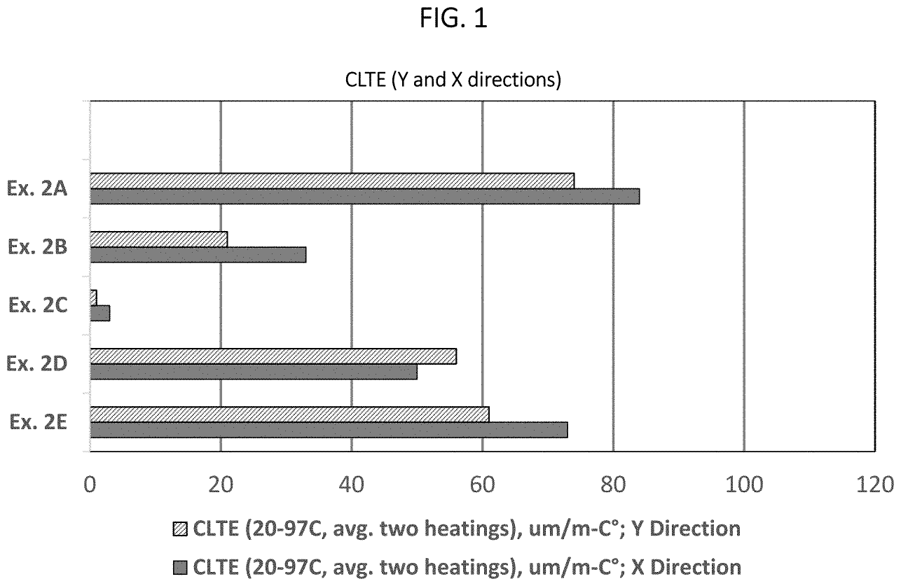

Table 3 and FIG. 1 show CLTE measurements for Examples 2A through 2F in X- and Y-directions over the temperature range of 20-97° C.

TABLE 3

| Composition | 2F | 2E | 2D | 2C | 2B | 2A |
|---|---|---|---|---|---|---|
| CLTE (20-97 C., avg. two | 4 | 73 | 50 | 3 | 33 | 84 |
| heatings), um/m-C. °; X Direction | | | | | | |
| CLTE (20-97 C., avg. two | 1 | 61 | 56 | 1 | 21 | 74 |
| heatings), um/m-C. °; Y Direction | | | | | | |

FIG. 1 and the CLTE values illustrate the surprisingly high dimensional stability of the cured object made with Examples 2C and 2F. The thermosetting resin of Example 2C and 2F had 70% unsaturation.

### Example 5

In this example, various properties of cured objects made by additive manufacturing using the compositions of Example 2 were determined. The measurements were generally made using procedures and techniques which are standard in the art and/or as described in Voeks et al. US Pat. App. Pub. 20200377719 and Nava et al. US Pat. App. Pub. 20200207895. The measurement of CLTE was performed as described in Example 4, with a temperature range of 0 to 160° C. Table 4 shows the various properties of Examples 2A through 2E, and demonstrates that Example 2C provides objects have desirable flexural PK or strength; flexural modulus; tensile PK or strength; tensile modulus; tensile elongation; compression PK or strength; compression modulus; and DMA Tan Delta, Tg.

TABLE 4

| | 2A | 2B | 2C | 2D | 2E | 2F |
|---|---|---|---|---|---|---|
| Viscosity, HBT Spindle 95 @ | 1,100,000 | 1,200,000 | 1,100,000 | 580,000 | 2,460,000 | 1,300,000 |
| 10 rpm, cps | | | | | | |
| Thixotropic Index | 7.0 | 9.2 | 7.5 | 4.1 | 8.7 | 5.1 |
| Density (Ibs./gal) - Liquid | 11.03 | 9.84 | 9.95 | 7.23 | 10.00 | 9.95 |
| Gel Time (min.) (CHP) | 14.0 | 16.5 | 40.0 | 18.1 | 21.2 | 17.5 |
| Gel to Peak Time (min.) | 15.0 | 36.0 | 20.0 | 10.9 | 19.2 | 35.5 |
| Peak Temp (F.) | 167 | 236 | 263 | 126 | 173 | 164 |
| Flexural PK or strength (ksi¹) | 5.3 | 10.9 | 3.3 | 7.2 | 10.4 | 4.0 |
| Flexural modulus (ksi) | 1,076 | 1,194 | 438 | 986 | 619 | 478 |
| Tensile PK or strength (ksi) | 3.4 | 6.74 | 2.3 | 3.5 | 5.2 | 2.2 |
| Tensile modulus (ksi) | 492 | 1,277 | 220 | 951 | 595 | 460 |
| Tensile Elong. (%) | 1.3 | 0.7 | 1.7 | 0.5 | 1.1 | 0.6 |
| Compression PK or strength | 8.6 | 19.1 | 5.0 | 8.5 | 12.6 | 4.5 |
| (ksi) | | | | | | |
| Compression Modulus (ksi) | 236 | 920 | 317 | 637 | 519 | 1246 |
| DMA² Tan Delta (° C. ), Tg | 98 | 143 | 169 | 100 | 97 | 161 |
| CLTE (0-160 C., 1st heat), | x = (50); | x = (36); | x = (8); | x = (35); | x = (46); | x = (4); |
| um/m-C. ° | y = (56); | y = (22); | y = (1); | y = (37); | y = (127); | z = (16) |
| | z = (168) | z = (129) | z = (83) | z = (166) | z = (176) | |

¹Kilopounds per square inch
²Dynamic mechanical analysis

These results demonstrate that additive manufacturing using the composition of Example 2C offers many advantages, including enhanced mechanical property retention (especially across layers in the Z-direction), and lower CLTE (with greatly enhanced dimensional stability across a broad temperature range).

### Example 6

In this example, the solubility of a LPA in various thermosetting materials was assessed using the following test procedure:

In Example 6-3, only styrene and the LPA were blended together at a 50/50% ratio. For Examples 6-2, 6-3, 6-4, and 6-5, mix by hand for 2 minutes a polybutadiene-containing vinyl ester resin with the 100% unsaturated polyester resin, such that the ratio is 40%/60% respectively. Blend into this mixture the amount of styrene monomer specified. This ranged from 4-15% (by weight to total) until mixture is clear. Blend into this mixture varying amounts of an LPA made from polyvinyl acetate and polyvinyl laurate. Transfer mixture into an 8 oz glass jar and seal with lid. Allow mixture to sit at room temperature (24-25° C.) for 10 days and monitor for change in turbidity and stratification. (phases) Samples that stratified during this time were sampled from each layer and submitted for compositional analysis.

The results of the experiments are shown in Table 5.

TABLE 5

| Example No. | 6-1 | 6-2 | 6-3 | 6-4¹⁰ | 6-5 |
|---|---|---|---|---|---|
| VE resin | | 31% | 35% | 31% | 31% |
| UPR resin | | 45% | 52% | 45% | 45% |
| Styrene | 50% | 12% | 0% | 12% | 12% |
| LPA | 50% | 12% | 13% | 12% | 12% |
| NMR | | | | | |
| Top strata | No strata. | VE resin, LPA, | VE resin, LPA, | LPA, less VE & | VE resin, LPA, |
| | Styrene & LPA | trace of UPR | trace of UPR | UPR resin | trace of UPR |
| Bottom strata | | UPR, VE, | UPR, VE, | | UPR, styrene, trace |
| | | no LPA | no LPA | | of LPA |
| FTIR | No strata. | | | | |
| | Styrene & LPA | | | | |
| Top strata | | Styrene & LPA | LPA | VE & UPR resin, | LPA |
| | | | | no LPA | |
| Bottom Strata | | VE & UPR resin | VE & UPR resin | | UPR |
| Glass jar | Clear | Turbid | Turbid | Clear jelly | Turbid |

¹⁰production drum surface

The LPA had a solubility percentage less than 15% in the thermosetting material. The experiments showed that the primary incompatibility occurred between the LPA and the UPR resin. The experiments also showed that the LPA has a high solubility in styrene monomer. However excess styrene is incompatible with the VE resin, so it is undesirable to include styrene monomer to solubilize the LPA. Based on these experiments, the amounts of thermosetting material components and LPA for the present additive manufacturing compositions were determined, and compositions were developed achieving low CTE and excellent dimensional stability.

As used herein, the terms “substantial” or “substantially” mean to within acceptable limits or degree to one having ordinary skill in the art. The terms “approximately” and “about” mean to within an acceptable limit or amount to one having ordinary skill in the art. The term “about” generally refers to plus or minus 15% of the indicated number. Whenever a number or value appears in the present disclosure, it should be understood that the approximate number or value is also contemplated. For example, where the specification says “10”, it should be understood that approximately 10 is also contemplated and disclosed herein. Whenever an approximate number or value appears in the present disclosure, it should be understood that the precise number or value is also contemplated and disclosed herein. For example, where the specification says “about 50”, it should be understood that 50 is also contemplated.

In the present disclosure, when percentages are used to identify the amount of a component, the percentages are based on the weight of the component over the total weight of the composition (unless the context indicates another basis of calculating the percentage). When a component is provided in a mixture (such as in a mixture comprising a diluent), the weight of the component itself (not including the diluent or other components in the mixture) is used to calculate its percentage in the composition.

The preceding description describes, illustrates and exemplifies one or more particular embodiments. This description is not provided to limit the disclosure to the embodiments described herein, but rather to explain and teach various principles to enable one of ordinary skill in the art to understand these principles and, with that understanding, be able to apply them to practice not only the embodiments described herein, but also other embodiments that may come to mind in accordance with these principles. Accordingly, the disclosure herein is meant to be illustrative only and not limiting as to its scope and should be given the full breadth of the appended claims and any equivalents thereof.

### REFERENCES

Heise et al. U.S. Pat. No. 5,296,544
Kunc et al. U.S. Pat. App. Publication No. 20150291833
Sand Int'l Publication No. WO2016086216A1
Sand Int'l Publication No. WO2016191329A1
Jones U.S. Pat. App. Publication No. 20120261060
Duty et al. U.S. Pat. App. Publication No. 20170057160
Duty et al. U.S. Pat. App. Publication No. 20180311891
Kishore et al., Additive Manufacturing 14 (2007) 7-12
Sudbury et al., Int J Adv Manuf Technol. (2017) 90:1659-1664
Nava U.S. Pat. App. Publication No. 20160096918
Nava et al. U.S. Pat. App. Publication No. 20200207895
Voeks et al. U.S. Pat. App. Publication No. 20200377719

The foregoing references, along with any other patents or publications mentioned in this disclosure, are incorporated by reference herein.

1. An additive manufacturing composition comprising:
a thermosetting material comprising a cross-linkable component having greater than 50% unsaturation
a low profile additive with a solubility percentage less than 15% in the thermosetting material or in a component thereof; and
a reinforcing material;
wherein the additive manufacturing composition has a viscosity of at least about 1,000,000 cps and a thixotropic index of at least 5.0.

2. The additive manufacturing composition of claim 1, wherein the thermosetting material comprises a vinyl ester component and an unsaturated polyester component

3. The additive manufacturing composition of claim 2, wherein the vinyl ester component is a toughened vinyl ester resin.

4. The additive manufacturing composition of claim 2, wherein the vinyl ester component is a vinyl ester resin containing polybutadiene.

5. The additive manufacturing composition of claim 2, wherein the unsaturated polyester component is a condensation product of a glycol and maleic acid or anhydride.

6. The additive manufacturing composition of claim 5, wherein the unsaturated polyester component has an acid number equal to or greater than 15.0 mg KOH/g.

7. The additive manufacturing composition of claim 2, wherein the unsaturated polyester component consists of a condensation product of propylene glycol and maleic acid or anhydride.

8. The additive manufacturing composition of claim 1, wherein the low profile additive comprises a vinyl acetate-vinyl ester copolymer, a vinyl ester-ethylene copolymer, a vinyl acetate isopropenyl acetate copolymer, a vinyl laurate, a vinyl acetate-vinyl laurate copolymer or mixture thereof.

9. The additive manufacturing composition of claim 8, wherein the low profile additive is essentially insoluble in the thermosetting material.

10. The additive manufacturing composition of claim 1, wherein the composition comprises:
12 to 45 wt % of an unsaturated polyester component having 50.0% or greater unsaturation; and
7 to 30 wt % of a vinyl ester component containing polybutadiene

11. The additive manufacturing composition of claim 1, wherein the composition comprises:
about 3 to about 30 wt % of the low-profile additive.

12. The additive manufacturing composition of claim 1, further comprising 5 to 25 wt % of an ethylenically unsaturated monomer.

13. The additive manufacturing composition of claim 1, wherein the composition comprises 5 to 50 wt % of the reinforcing material.

14. The additive manufacturing composition of claim 1, wherein the reinforcing material comprises carbon fibers, glass fibers, natural fibers or a mixture thereof.

15. An object produced from curing the additive manufacturing composition of claim 1, wherein the object has a coefficient of linear thermal expansion (CLTE) of 10 um/m-° C. or less in X and Y directions, and 100 um/m-° C. or less in a Z direction, over a temperature range of 0° C. to 160° C.

16-19. (canceled)

20. The object of claim 15, wherein the object exhibits less than 2% (by volume) of voids.

21. A method of additive manufacturing an object comprising:
depositing a first layer of the additive manufacturing composition of claim 1 on a support at a deposit temperature; and
curing the deposited composition.

22. (canceled)

23. The method of claim 21, further comprising depositing a second layer of the additive manufacturing composition on the first layer opposite the support, wherein the second layer is deposited after the first layer has reached a temperature between about 38 and about 43° C.

24. The method of claim 21, further comprising depositing layers such that each layer does not exceed 127° C.

25-26. (canceled)

27. The method of claim 21, wherein the curing of the additive manufacturing composition is at a temperature of 20° C. to 50° C.

28. (canceled)
